(19) United States
(12) Patent Application Publication
(10) Pub. No.: US 2011/0044879 A1
(43) Pub. Date: Feb. 24, 2011

(54) PROCESS FOR THE TREATMENT AND PURIFICATION OF DANGEROUS WASTES CONTAINING AMMONIUM SALTS, PARTICULARLY AMMONIUM CHLORIDE, DERIVED FROM PHARMACEUTICAL AND CHEMICAL TECHNOLOGIES

(76) Inventor: János György Soós, Monostorpalyi (HU)

Correspondence Address: HAHN & VOIGHT PLLC, 1012 14TH STREET, NW, SUITE 620, WASHINGTON, DC, 20005, US

(21) Appl. No.: 12/293,837

(22) PCT Filed: Mar. 22, 2007
(86) PCT No.: PCT/HU2007/000028

§ 371 Date: Aug. 12, 2010

(30) Foreign Application Priority Data
Mar. 22, 2006 (HU) P0600242

(51) Int. Cl. C01C 1/16; C01C 1/00; C01C 1/242; C01C 1/18; C01B 7/05

(52) U.S. Cl. 423/356; 423/471; 423/549; 423/396; 423/481

(57) ABSTRACT

The invention relates to a process for the treatment and purification of dangerous wastes containing ammonium salts, particularly ammonium chloride, derived from pharmaceutical and chemical technologies. The process includes the following steps: removing the organic solvent content of the waste mixture, containing an aqueous and non-aqueous phase, by phase separation based on the difference in the special weight and/or by azeotrop distillation, and heating the obtained aqueous solution at its boiling point or at a temperature belonging to the maximal saturation boiling point of the ammonium salt until the non-solvent type organic substances precipitate in the form of a well separable polymerisate phase, whereafter this phase is separated from the aqueous solution of the ammonium salt and the ammonium salt, preferably the ammonium chloride is purified by a method known per se.

The present invention is related to a treatment and purification process of dangerous wastes containing water-soluble ammonium salts, particularly ammonium bromide, ammonium iodide, ammonium chloride, particularly ammonium chloride being heat-stable at the boiling point of their aqueous solution. The field of application of the process of the invention is the pharmaceutical industry, the chemical industry and particularly the treatment of dangerous wastes within the technologies for environment protection. By the process of the invention ammonium salts, particularly ammonium chloride can be purified from various organic and/or inorganic contaminants, such as water-soluble carbohydrates or various heavy metal salts or even the residues of organic extracting agents and a product of arbitrary purity can be obtained.

The process according to the invention can preferably be applied in the field of environment protection, more closely for the treatment of dangerous wastes containing as characteristic contaminant, a given type of ammonium salt, preferably ammonium chloride. The occurrence of such wastes is rather frequent. In the pharmaceutical fermentation technologies during the preparation of the target product such types of wastes are formed as a result of the extraction purification of the aqueous fermentation broth by extraction with an organic solvent and as a result of the precipitation with ammonium chloride. One such waste type is for instance a solution formed during the production of statins, containing as an aqueous phase ammonium chloride and culture medium components, and as a non-aqueous phase a mixture containing mainly isobutyl acetate.

Ammonium salts and their aqueous solutions containing such type of substances, such as water-soluble organic substances, culture media, metabolites and decomposition products of micro-organisms or dangerous organic substance being not well soluble in water, or water-soluble inorganic salts, heavy metal components, are considered at the present as dangerous wastes, as there is no such preferred purification method which could be simply and profitably applied under industrial conditions.

Wastes, which are considered dangerous, can contain water-soluble organic substances, which can be present in a concentration commensurable with that of the ammonium salts, and their removal can be carried out in many steps or it cannot be carried out at all by methods known per se. Such organic substances can be e.g. sugars (such as glucose), oligosaccharides or polysaccharides or (such as dextrin or starch), gelling substances, such as collagens, agar-agar or gelatines), further amino acids, peptides, proteins (such as albumins or globulins), or nucleic acid derivatives, as well-known components of culture media.

These wastes are handled at the present by burning in furnaces. The main disadvantage of the burning of the wastes is that all the components of the waste get lost and when burning these wastes above 1000° C. NOx outlet gases are formed in high concentration due to the high ammonium ion content. To remove these flue gases completely, expensive and complicated washing equipment is required. In case of the widely used ammonium chloride and other ammonium halides it is a further danger that due to their halogen content they form dioxin-type compounds with the possibly present aromatic, heteroaromatic ring containing derivatives, while with other organic materials dangerous halogen derivatives are formed, which can get to the atmosphere and as exhausted liquids of the flue gas washers they mean a high potential of danger, when stored. Further the ammonium halides practically entirely dissociate thermally to form hydrochloric acid or the corresponding hydrogen halide and ammonia gas, and not only the steel but also other constructional materials are corroded at a furnace temperature above 1000° C. Due to their low burning heat the burning of said materials requires much energy because of the water contents of about 70/80% by weight.

The deposition after drying of such wastes is also a bad solution, as no valuable components can be obtained from the waste and the storing in isolated concrete basins is also a potential source of danger. This method is handled by the new law rather strictly and several provisions are provided.

The ammonium salts can theoretically be recovered from such wastes by crystallization, but in the practice this separation-purification method cannot be applied, as even after repeated crystallization steps the ammonium salts remain contaminated to various extent by organic materials, and the operations need much time and big volumes of solution, and due to the changing composition of the mother liquor the product is variously contaminated. A crystallization method is discussed in U.S. Pat. No. 7,127,913, wherein crystallization at the eutectic freezing point is carried out.

It is also known that during the Solvay soda production ammonia can be set free from ammonium salts by heating with a strong base, but the absorption of the same and equivalent neutralization with a suitable acid and the additional purification is not suitable for the treatment of such heterogeneous waste of small amount compared to this technology.

A more modern method is the membrane technology separation with a suitable membrane, possibly by using a reverse osmosis method. The disadvantage of these methods is that both the membrane and the equipment are expensive, and a theoretical disadvantage is that the floating substances of different particle size being always present in the wastes and the labile organic substances block the pores of the membrane and thereby the membrane becomes unserviceable (High Beam Research China Chemical Reporter Jun. 5, 2004).

The task of the present invention was to elaborate a method for the treatment of wastes eliminating the disadvantages of the methods mentioned above such as the burning treatment of dangerous waste types, and to find such a method, the application of which provides ammonium halides, preferably ammonium chloride from the waste at an arbitrary degree of purity and to make the dangerous waste unharmful. In connection with pharmaceutical or chemical technologies producing the above wastes the process of the present invention makes it possible that by increasing the volume of the production the amount of the main contaminating component: the ammonium salts, preferably the ammonium chloride does practically not increase, but can be recovered and led back into the given technology as a pure substance.

We have surprisingly found that in a hot, concentrated ammonium chloride solution, when heating the solution particularly at the saturation boiling point, when the temperature of the liquid space is about 115-116° C., after a while the water-soluble carbohydrates, starch-type substances and other organic substances form a viscous, tar-like fluid phase separating from the aqueous phase, clumps are formed and during heating they slowly get precipitated, coagulated or polymerised. This phenomenon, which has been recognized, cannot be easily explained by the traditional organic chemical way, as it is no primary or secondary salt effect, it is not exactly pyrolysis, not exactly polymerisation and it cannot be found in the literature dealing in detail with the chemical reactions of carbohydrates. One can only say about this phenomenon that it is similar to the preparation of the so-called sugar couleur as an additive of liqueur industry, wherein the melted sugars are heated at 130° C. under pressure for a sufficient time in the presence of catalytically active additives, such as ammonium salts or amino acids, while they are converted to a caramel-type brown substance of so far unknown composition. The organic medium components derived from the fermentation technology, such as corn sugar, gelatine, etc., can be separated according to the invention from the concentrated solution containing ammonium chloride, as at the boiling point of the saturated solution this polymerisate forms a supernatant phase which can be decanted or separated by any other suitable physical method. Thus ammonium chloride of about technical quality can be prepared. This process takes place also in the presence of ammonium bromide or iodide, and due to the even better water solubility of these substances even higher atmospheric boiling point can be applied. (The ammonium fluoride decomposes upon heat, therefore ammonium fluoride cannot be treated by this method.)

The consistence of the precipitated polymerisate phase can be amended within a certain range by adding active charcoal and/or other inactive powders. Without adding these mentioned materials, such as by dipping a glass rod into the mixture, a thin fibre can be drawn out from it but this tendency of drawing a fibre can be reduced by using these additives.

When carrying out the process according to the present invention the organic solvents or solvent mixtures dissolved in the aqueous phase can simultaneously be removed during the concentration, as the dangerous waste types derived from the fermentation-extraction technologies can contain the organic solvents in two layers: as the supernatant organic heterogeneous phase practically not containing any inorganic component and water also only in a small amount, and dissolved in a lower aqueous phase with a high inorganic salt content. These two layers can be simply separated from each other on the basis of the difference in the specific weight. The aqueous layer can homogeneously dissolve only a small amount of organic solvent due to it high ammonium chloride content and due to the precipitation, therefore the organic solvent content dissolved in the aqueous layer can be removed by simple heating—simultaneously with the concentration which is needed in order to carry out the above recognized reaction—by forming various azeotrop mixtures with water. In order to form an azeotrop mixture in most cases it is sufficient to use the organic solvent which is already in the mixture, such as isobutyl acetate, but if necessary, a different azeotrop-forming agent can be added as well.

If it is desirable to recover an ammonium chloride of higher purity than the technical purity, the well-known sublimation can be used in relation to the ammonium chloride, and this procedure takes place at about 350° C. This process is in fact not a layer equilibrium procedure but a thermal decomposition reaction: the ammonium chloride decomposes to hydrochloric gas and ammonium gas upon heat, and upon cooling it reacts again, and therefore traces of water are needed for instance during the condensation. We have found that at the temperature of the sublimation the organic substances are subjected to pyrolysis or carbonification in an oxygen-free space, and as a sublimation residue they remain in the mixture and the pyrolysis products do not contaminate the ammonium chloride formed during the condensation of hydrochloric acid or ammonium gases at 350° C.

The ammonium chloride—which is still contaminated and is evaporated or crystallized from the aqueous layer—can be converted to a useful material by heating them in the presence of strong bases, such as sodium hydroxide, calcium hydroxide or hydrochloric acid binding agents releasing ammonium gas, which can be absorbed in different absorbent solutions: for instance ammonium hydroxide solution can be obtained by absorption in water, ammonium sulphate can be obtained by absorption in sulphuric acid or sulphuric acid solution and ammonium nitrate is obtained by absorbing in nitric acid. The latter two materials are valuable as nitrogen fertilizer as opposed to ammonium chloride, which can cause the clorosis of plants when using it in agriculture.

If we heat ammonium chloride being still contaminated after crystallization from the aqueous layer with sulphuric acid or sulphuric acid solution, the chloride content leaves the reaction mixture in the form of hydrochloric acid gas, which can be used for other purposes as gas or can be absorbed in water, but it results in a useful, pure material and not a waste.

According to the process of the invention the supernatant organic solvent forming a heterogeneous layer can be separated from the title dangerous waste preferably on the basis of the difference in the specific weight (e.g. by sedimentation or by using a separator centrifugal machine etc.), whereafter the aqueous layer is concentrated by atmospheric distillation or under pressure, preferably until the saturation concentration of ammonium chloride. By using a higher pressure than atmospheric pressure, the boiling point can be further increased and thereby the reaction takes places sooner and a polymerisate layer of lower viscosity is obtained. This is followed by the filtration of the polymerisate layer, cooling of the filtered solution and filtration of the crystallized ammonium chloride (e.g. in a filtering centrifugal machine) and drying. Thereafter the dry ammonium chloride is heated in a sublimating machine and the sublimate is separated already as a pure product.

According to the process of the invention:

the organic solvent content derived from pharmaceutical industrial or chemical industrial technologies containing aqueous and non-aqueous layers is separated from the dangerous waste mixture during the cold or thermal treatment, e.g. isobutyl acetate is removed on the basis of the difference in the specific weight by layer separation and/or by azeotrop distillation,

the obtained ammonium salt, preferably ammonium chloride containing aqueous layer is heated at the boiling point of the solvent or at a temperature close to the boiling point, optionally at a higher pressure than the atmospheric pressure, until the non-solvent type organic material fully precipitate from the solution in the form of separable conglomerates (polymerisate), whereafter this layer is separated from the aqueous solution of the ammonium salt,

the ammonium salt in the form of aqueous solution is evaporated and/or crystallized either by ion exchange or by membrane technique method,

and the ammonium salt obtained in solid form is purified by sublimation or vacuo sublimation or recrystallization by a method known per se.

For the azeotrop distillation or vacuo azeotrop distillation the organic solvent, preferably isobutyl acetate included in the waste is used, or an azeotrop-forming agent being originally not present in the waste can also be applied.

During the preferred method according to the invention the solution is heated at a temperature near to the maximal saturation boiling point of the ammonium chloride, i.e. at 100-120° C.

In order to improve the layer consistence of the separating organic conglomerates solid excipients, such as active charcoal can be added to the aqueous solution.

### EXAMPLE

The used waste derived from the preparation of statin compounds prepared by combining aqueous residues and residues of solvent extraction or residues of culture media, the precise composition of this mixture is not completely known, only characteristic values have been defined. The waste contained a supernatant organic solvent, e.g. an isobutyl acetate layer, a homogeneous aqueous layer and a solid, brownish ammonium chloride crystal mass. The crystals are filtered and the isobutyl acetate layer separated on the basis of the specific weight is decanted and discarded as a waste. The previously filtered crystal mass is added to the decanted aqueous layer which is dissolved during heating. The composition of the homogeneous aqueous layer in warm state is as follows:

| | | |
|---|---|---|
| ammonium chloride | 20.5% | by weight |
| isobutyl acetate | <3% | by weight |
| other materials: acetone, i-BuOH, acetic acid | <3% | by weight |
| corn sugar | 3% | by weight |
| NaCl | 0.1% | by weight |
| ammonium sulphate | 0.3% | by weight |
| iron(III)chloride | 0.3% | by weight |
| fermentation debris compounds | <1% | by weight |
| microelements | <1% | by weight |
| water | | |

A multinecked round bottom flask equipped with a distillation head, a thermometer reaching to the liquid space and equipped with a wide lock-up opening, containing 1000 g dark brown aqueous layer is heated by a heating basket. At the beginning an azeotrop system consisting of isobutyl acetate—water—other solvent is distilled, followed by the distillation of pure water. At the beginning the temperature of the solution at the boiling point is 103° C., which increases to 116° C. by the concentration of the solution. The temperature values of the liquid are only informative and not equilibrium values, as we have not used any barometric correction and we have not defined the extent of the superheating depending also on the intensity of the heating. At this time the volume of the solution is reduced to about ⅔ or ½. By reaching this maximal temperature of the solution, the distillation head of the flask is replaced by a reflux cooler and the boiling is continued. During this procedure the colour of the solution gets cleaner, showing the reduction of the contamination and simultaneously smaller clumps are formed in the solution. These clumps go to the upper part of the boiling solution by the progression of time, and a tar-type organic coagulate of dark brown colour is formed, forming thus a polymerisate layer. After 3 hours the amount of this coagulate no longer increases. By ceasing the heating the coagulate layer deposits at the bottom of the solution and contaminates the separating ammonium chloride crystals crystallizing upon heating or a part thereof, therefore the coagulate layer is preferably decanted from the boiling solution or it is preferred to remove it by any other method. The decanted coagulate weighs 36 g. Afterwards the hot saturated aqueous ammonium chloride solution is evaporated to dryness and pulverized. The air-dry ammonium chloride weighs 217 g and the humidity content amounts to 7.3% by weight, the NH₄Cl content calculated to the dry substance is 96.2% by weight, corresponding to a technical quality. By sublimating this product of technical quality a product of analytical purity is obtained, the NH₄Cl content of which is higher than 99.8% by weight.

1. Process for the treatment and purification of dangerous wastes containing ammonium salts, particularly ammonium chloride, derived from pharmaceutical and chemical technologies which comprises removing the organic solvent content of the waste mixture, containing an aqueous and non-aqueous phase, by phase separation based on the difference in the special weight and/or by azeotrop distillation, and heating the obtained aqueous solution at its boiling point or at a temperature close to the boiling point, preferably at a temperature belonging to the maximal saturation boiling point of the ammonium salt, preferably ammonium chloride until the non-solvent type organic substances precipitate in the form of a well separable polymerisate phase, whereafter this phase is separated from the aqueous solution of the ammonium salt and the ammonium salt, preferably the ammonium chloride is purified by a method known per se.

2. A process as claimed in claim 1 which comprises conducting the heating of the aqueous solution at atmospheric pressure at 10-120° C.

3. A process as claimed in claim 1 which comprises conducting the heating of the aqueous solution at a pressure higher than atmospheric pressure.

4. A process as claimed in claim 1 which comprises subjecting the ammonium salt, preferably ammonium chloride obtained in the form of an aqueous solution to evaporation and/or crystallization or to an ion exchange treatment or a membrane technique treatment and purifying the ammonium salt, preferably ammonium chloride by sublimation or vacuum sublimation or recrystallization by a method known per se.

5. A process as claimed in claim 1 which comprises applying atmospheric or vacuum azeotrop distillation or rectification by using only the waste or such azeotrop forming agent, which was already included originally in the waste.

6. A process as claimed in claim 1 which comprises adding solid excipients to the waste in order to change the consistence of the separating organic polymerisate phase to improve the separability.

7. A process as claimed in claim 1 which comprises heating the crystallized ammonium salt, preferably ammonium chloride in the presence of strong bases or strong non-volatile acids or acid binding agents and separating the formed NH₃ gas or hydro halide, preferably hydrochloric acid gas or absorbing same in water to get useful substances and/or by preparing pure ammonium salt, preferably ammonium chloride by reacting the thus formed ammonium hydroxide with hydro-halide acid, preferably hydrochloric acid.
